(19) United States
(12) Patent Application Publication
(10) Pub. No.: US 2019/0364910 A1
(43) Pub. Date: Dec. 5, 2019

(54) METHOD AND DEVICE FOR PRODUCING A ROLL MADE OF A DOUGH PIECE AND A SEPARATOR SHEET

(71) Applicant: FRITSCH GMBH, MARKT EINERSHEIM (DE)

(72) Inventor: UDO BERNHARDT, Iphofen (DE)

(21) Appl. No.: 16/349,826

(22) PCT Filed: Sep. 19, 2017
(86) PCT No.: PCT/EP2017/073587

§ 371 Date: May 14, 2019

(30) Foreign Application Priority Data
Nov. 22, 2016 (DE) 10 2016 122 447.2

(51) Int. Cl. A21C 3/06

(52) U.S. Cl. CPC A21C 3/06

(57) ABSTRACT

A method for producing a roll made of a dough piece and a separator sheet includes feeding the dough piece onto a separator sheet web moved in a conveying direction; cutting-to-length the separator sheet web to form a separator sheet which is assigned to the dough piece and has a front edge in front of the dough piece and a rear edge behind the dough piece, the separator sheet protruding from below the dough piece at the front edge and/or the rear edge with a front protrusion and/or a rear protrusion; rolling up the separator sheet with the dough piece to form the roll; wherein a separator sheet web is used which has a residual-stress state, the residual stress of the separator sheet web causing the cut-to-length separator sheet to roll up automatically at the front edge and/or the rear edge after termination of the cutting-to-length process.

### CROSS-REFERENCE TO RELATED APPLICATIONS

This application represents the national stage entry of PCT International Application No. PCT/EP2017/073587 filed on Sep. 19, 2017 and claims priority to German Patent Application No. 10 2016 122 447.2 filed on Nov. 22, 2016. The contents of these applications are hereby incorporated by reference as if set forth in their entirety herein.

The disclosure relates to a method and a device for producing a roll made of a dough piece and a separator sheet according to the teaching of the independent main claims.

Both in the household and for bulk consumers, the even rolling out of doughs, such as cake dough, short pastry, puff pastry or pizza dough, is a considerable problem. If one does not have a rolling machine at one's disposal, it is almost impossible to obtain an even thickness of the dough piece. There has therefore for a long time been a considerable need for prefabricated rolled out dough pieces. In order to facilitate the storage and the processing of prefabricated rolled out dough pieces, it is common practice to supply the rolled out dough pieces already together with a separator sheet. Thereby, the separator sheet serves to prevent the rolled out dough piece from sticking together. If the separator sheet is made of baking paper it furthermore can provide added value when the dough piece is used during the baking process. In addition to delivery forms made of dough pieces and separator sheets folded into folded packages, in particular rolls made of a dough piece and a separator sheet have proven to be particularly advantageous for the storage and distribution of prefabricated dough pieces. One reason for this is that in rolled dough pieces wrinkling in the dough, which even remains visible after baking, is avoided. Furthermore, a roll made of a dough piece and a separator sheet needs a minimal storage space so that the prefabricated rolls made of a dough piece and a separator sheet can be packed up in relatively small packaging units. For the production of rolls made of dough pieces and separator sheets, there are known different methods and devices from the state of the art.

EP 0 230 335 A2 describes a device having a winding reel. Said winding reel grips the front edge of the dough piece along with the separator sheet adhering to it so that a roll made of a dough piece and a separator sheet can be produced by a subsequent rotation of the winding reel. This roll is then removed from the winding reel and packed up. The disadvantage of this method is that it has a high process time and furthermore tends to wrinkle in the grip area of the winding reel.

EP 2 529 629 B1 describes a method for producing rolls made of a dough piece and a separator sheet, in which, first of all, a cylinder is rolled from the separator sheet material in a rolling device for producing the roll. Then, only after the formation of a complete cylinder, which consists of the separator sheet material, the dough piece is wound onto said cylinder together with the rest of the separator sheet material. The disadvantage of this method is that, first of all, a complete cylinder has to be rolled out of the separator sheet material. Since the separator sheet material is usually very thin and has a high degree of instability at the front edge of the sheet, this method is relatively susceptible to disruptions. In particular at high cycle frequencies with corresponding high conveying speeds, the separator sheet material, which is for example baking paper, tends to be uncontrolledly folded and warped so that the whole winding process is disturbed and possibly interrupted thereby.

From EP 0 158 590 B1 a method for producing a roll made of a dough piece and a separator sheet is known, in which, first of all, before the actual rolling up of the roll, the front edge and the rear edge of the separator sheet material are folded back over the front edge and/or the rear edge of the dough piece, so that the corresponding protrusion of the separator sheet material then rests on the upper side of the dough piece. By this resting of the protrusion, the front edge and/or the rear edge of the separator sheet material are stabilized mechanically by the dough material so that disruptions caused by uncontrolled movements of the protruding separator sheet material are made impossible. However, an additional handling device, which in turn has a high susceptibility to disruptions, is necessary for the folding over of the protrusion of the separator sheet material. For usually the folding over of the protrusion is caused by corresponding blowing nozzles; however, in particular, when there are very short cycle times with corresponding high conveying speeds, it can occur that the folding over is not performed neatly in the area of the protrusion and then, in turn, disruptions are caused.

Based on this state of the art, the object of the present disclosure thus is to propose a new method and a new device for producing a roll made of a dough piece and a separator sheet.

The method according to the disclosure is based on the fundamental idea that a separator sheet web, which has a residual-stress state in the direction of the conveying movement, is used for the production of the roll made of a dough piece and a separator sheet. Thereby, this residual-stress state has to be selected in such a manner that the separator sheet rolls up automatically after having been cut-to-length. By this automatic rolling up of the cut-to-length separator sheet web in the area of the front edge and/or the rear edge a strong mechanical stabilization of the front edge and/or the rear edge is realized so that an uncontrolled warping or folding over of the separator sheet web before, during and after the rolling of the roll made of a dough piece and a separator sheet is made impossible.

The geometry of the rolled up front edge and/or the rolled up rear edge which results from the rolling up of the cut-to-length separator sheet web caused by the residual stress is generally optional. The higher the residual stress of the separator sheet web in the direction of the conveying movement, the smaller the rolling radius of the protrusion in the area of the front edge and/or the rear edge. The geometry of the rolled up protrusion can be influenced by the corresponding variation of the residual-stress state before the separator sheet web is cut-to-length and by the length of the protrusion, i.e. the distance between the front edge of the separator sheet and the front edge of the dough piece and/or the distance between the rear edge of the separator sheet and the rear edge of the dough piece. The geometry of the rolled up protrusion in the area of the front edge is particularly important for the process reliability in the production of the roll made of a dough piece and a separator sheet. For, if the front edge enters the winding device for the production of the roll uncontrolledly, disruptions during the rolling process occur almost inevitably. It is therefore particularly advantageous if the separator sheet has a front protrusion at the front edge with respect to the front edge of the dough piece, the front edge of the separator sheet coming to rest on the upper side of the dough piece by the automatic rolling up caused by the residual-stress state. During the subsequent rolling up of the roll, the front protrusion of the separator sheet is then folded over the front edge of the dough piece due to this geometry so that the protrusion of the separator sheet envelops the front edge of the dough piece. The front edge of the separator sheet is mechanically stabilized decisively due to the fact that it rests on the upper side of the dough piece so that an uncontrolled bending or folding over of the separator sheet in the area of the front edge is made impossible also in the case of high conveying speeds and high rolling speeds.

Furthermore, it is particularly advantageous if the separator sheet also at its rear edge has a rear protrusion with regard to the rear edge of the dough piece. After the rolling up of the roll made of a dough piece and a separator sheet, said rear protrusion of the separator sheet can envelop the roll on its entire outside. By enveloping the roll on the outside in this manner, a fixation of the roll is achieved so that in particular the otherwise usual adhesive areas, with which the rear edge of the separator sheet is fixed on the roll made of a separator sheet and a dough piece, can be omitted. Depending on the length of the rear protrusion, the rear protrusion can also envelop the roll made of a dough piece and a separator sheet circularly on the outside in several layers and fix it correspondingly well.

Another advantage of the method with respect to the possible cycle times is that the automatic rolling up of the separator sheet at the front edge and/or the rear edge leads to the formation of a distance in the conveying direction between the separator sheets arranged one after the other. For the separator sheets arranged one after the other are separated from each other by this distance to such an extent that it is made impossible for the front edge of the following separator sheet to be drawn in during the rolling process of the preceding separator sheet.

For carrying out the method according to the disclosure a separator sheet web is required which, at the latest during the cutting-to-length process, has a residual-stress state by which the separator sheet emerging in this process is rolled up automatically at the front edge and/or the rear edge. However, many separator sheet materials, such as baking paper, are usually not supplied with such a residual-stress state. Rather, the usual separator sheet materials have a state without any residual stress so that the separator sheet material essentially does not roll up without a corresponding external impact.

In order to be able to use such separator sheet materials that do not have any residual-stress state of their own for the method according to the disclosure, the device according to the disclosure has an impact device by means of which a corresponding residual-stress state of the separator sheet web can be generated.

The way in which the impact device varies the residual-stress state of the separator sheet web in order to generate the desired residual-stress state is generally optional. This impact can be achieved especially easily and effectively when the separator sheet web is deformed in a suitable manner before the cutting-to-length process is performed. It is therefore provided according to a preferred device variant that the impact device comprises a traction conveyor device and a deflection device. By means of the traction conveyor device a tensile stress of sufficient intensity can be applied on a certain section of the separator sheet web. The separator sheet web section which is thus under tensile stress is then deflected by a deflection angle at the deflection device. Due to the deflection of the separator sheet web at the deflecting device, microscopic deformation occurs between the upper side and the bottom side of the separator sheet web. In particular, certain types of paper having a corresponding fiber content can be deformed well by this deflecting process, and a residual-stress state can be generated by which an automatic rolling up of the separator sheet web at the cutting edges is made possible. This deflecting process for generating a residual-stress state is also called “curling”.

The size of the deflection angle for the deflection of the separator sheet web at the deflecting device is generally optional. In order to achieve a sufficient impact on the separator sheet web and in order to be able to thereby generate the desired tensile stress state it is particularly advantageous if the deflection angle of the deflecting device is between 90 degrees and 179 degrees.

The way in which the traction conveyor device is designed structurally is generally optional. Preferably, the traction conveyor device should comprise a pair of draw rollers disposed in the conveying direction downstream of the deflection device, the separator sheet web being conveyed through between said pair of draw rollers by applying a driving force.

Furthermore, the traction conveyor device should preferably comprise a braking means disposed in the conveying direction upstream of the deflection device, the conveying movement of the separator sheet web being able to be decelerated by means of said braking means. By the interaction between the pair of draw rollers, by means of which the separator sheet web is drawn in the conveying direction, and the braking means, which is arranged upstream and by means of which the separator sheet web is decelerated, the required tensile stress can easily be built up in the separator sheet web.

The braking means can preferably be formed like a shaft brake by means of which the bearing shaft, on which a supply roll of the separator sheet web is rotatably mounted, can be decelerated. In order to be able to vary the tensile stress in the separator sheet web depending on the process, a braking means which is adjustable in terms of the braking effect and/or a pair of draw rollers which is adjustable in terms of the driving force can be used. While the deflection angle remains the same, the rolling radius, with which the separator sheets roll up automatically after termination of the cutting-to-length process, can be adjusted by varying the tensile stress.

The deflection device itself can be formed in a simple manner like a deflection bar which comes into contact with a deflecting edge at the separator sheet web. Depending on the radius of the tip of the deflecting edge, the deformation of the separator sheet web can be varied during deflection so that, in addition to the tensile stress and the deflection angle, a further influencing parameter is available.

The “curling” can be carried out particularly effectively if the deflection device engages with a wedge-shaped deflecting edge at the separator sheet web. The sharp delimitation of the contact surface between the deflecting edge and the separator sheet web causes a relatively strong deformation of the separator sheet web so that the separator sheets roll up automatically with a relatively small rolling radius after the cutting-to length process.

The cutting-to-length device which serves to cut through the separator sheet web to form the front edge and/or the rear edge can preferably be formed like a bar knife.

It is particularly advantageous if the device comprises an adjustable holding-down device which can be adjusted between an engaged position and a rest position. The holding-down device in the engaged position thereby comes into contact with the rear protrusion of the separator sheet and ensures that the rear protrusion of the separator sheet which has rolled up automatically due to the residual stress unrolls again before entering the winding device and wraps itself neatly around the outside of the rolled up roll. In the rest position, the holding-down device is pivoted back so far that the conveying through of the dough piece toward the winding device is made possible.

An embodiment of the disclosure is schematically illustrated in the drawing and will be explained in more detail below.

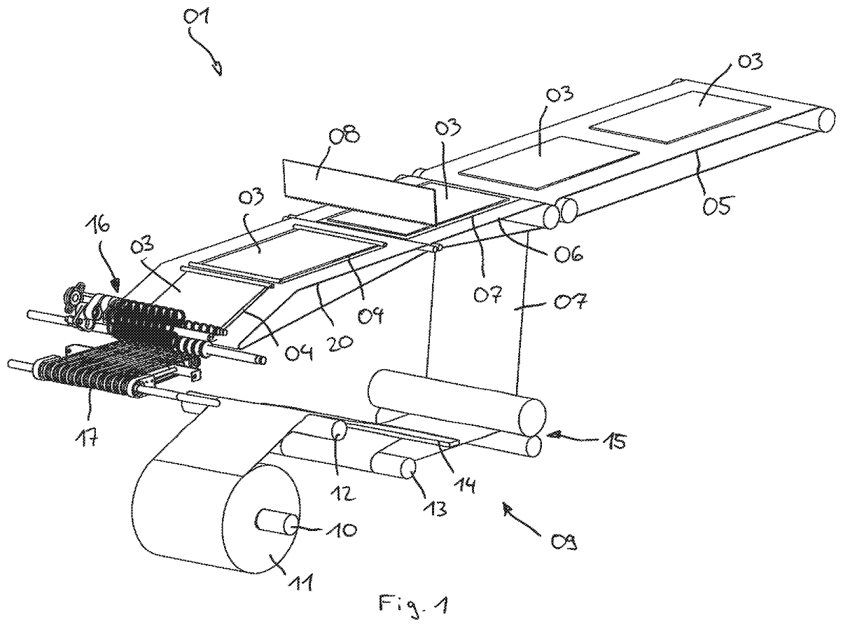

FIG. 1 shows a perspective top view of a device for producing a roll made of a dough piece and a separator sheet;

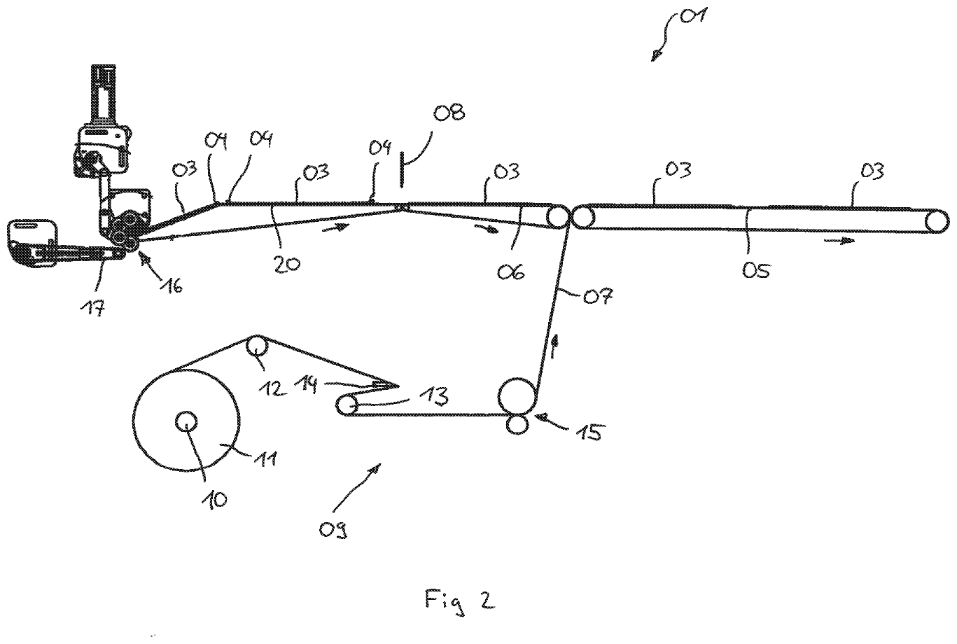

FIG. 2 shows a side view of the device according to FIG. 1;

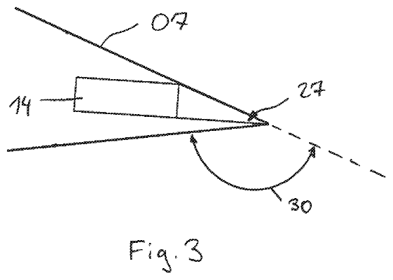

FIG. 3 shows an enlarged side view of the deflection device according to FIG. 1;

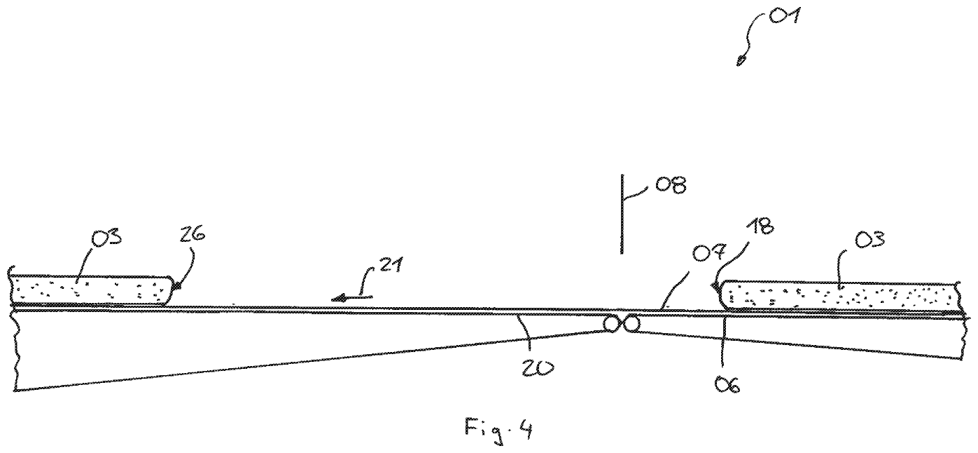

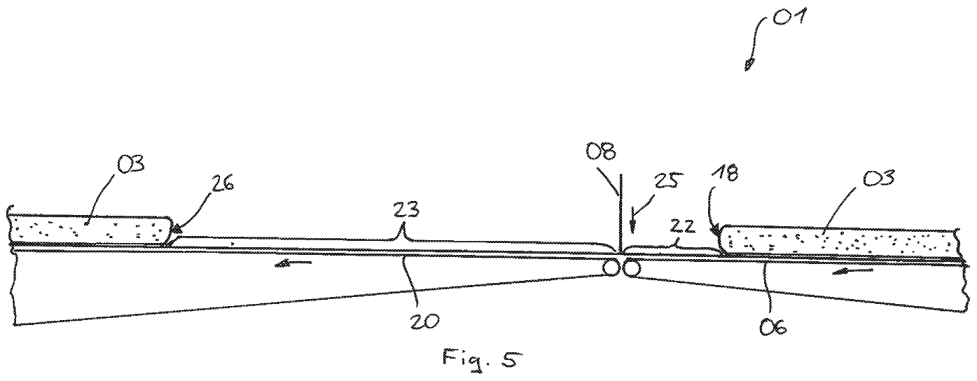

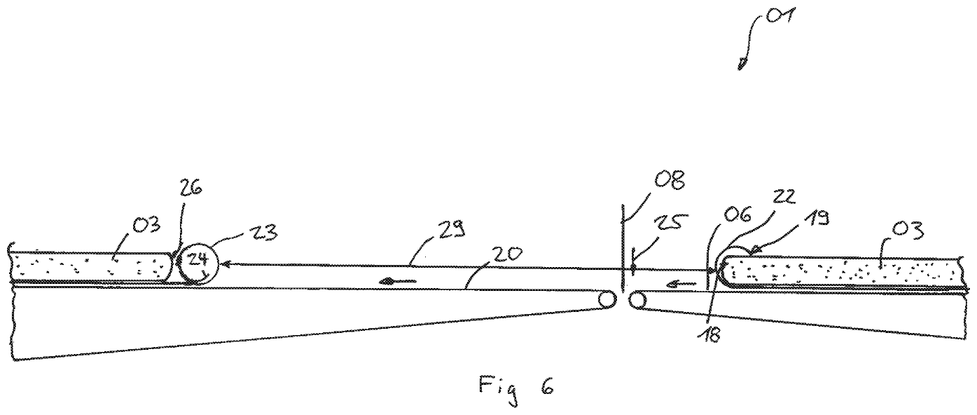

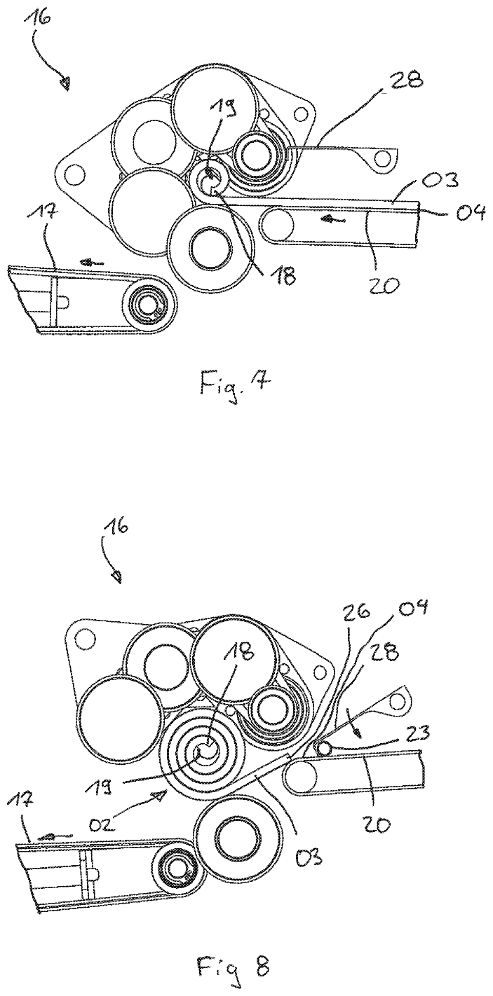

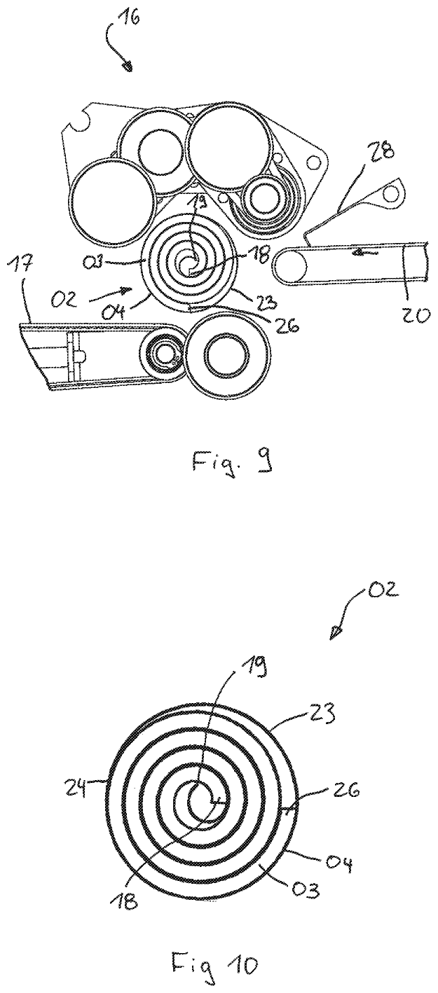

FIG. 4 shows the separator sheet web conveyed by the device according to FIG. 1 with the dough pieces resting on it in the area of the cutting-to-length device before the cutting-to-length process is performed;

FIG. 5 shows the separator sheet web with the dough pieces resting on it according to FIG. 4 when the cutting-to-length device is put down on the separator sheet web;

FIG. 6 shows the separator sheet web according to FIG. 5 with the dough pieces resting on it after the cutting-to-length process has been performed by means of the cutting-to-length device;

FIG. 7 shows an enlarged side view of the winding device of the device according to FIG. 1 at the beginning of the process of rolling up a roll.

FIG. 8 shows an enlarged side view of the winding device according to FIG. 7 at the end of the process of rolling up a roll.

FIG. 9 shows an enlarged side view of the winding device according to FIG. 7 after termination of the process of rolling up a roll.

FIG. 10 shows an enlarged side view of the roll made of a dough piece and a separator sheet, which has been rolled up according to the manner shown in FIG. 7 to FIG. 9.

FIG. 1 shows a device 01 for producing rolls 02 (see FIG. 10), each roll being made of one dough piece 03 and one separator sheet 04. The dough pieces 03, which, for example, can be pizza dough or cake dough, having been conveyed by means of a conveying device 05, are transferred to a feeding device 06. In the feeding device 06 the dough pieces 03 are placed on a separator sheet web 07 fed from below, which, for example, can be baking paper material.

After the dough pieces 03 have been placed on the separator sheet web 07, the separator sheet web 07 is subsequently cut-to-length by means of a cutting-to-length device 08, which is formed like a bar knife, to thereby form separator sheets 04 which are assigned to the individual dough pieces 03.

Before feeding the separator sheet web 07 to the feeding device 06, said separator sheet web 07 is deformed in an impact device 09 in such a manner that a predetermined residual-stress state is generated in the separator sheet web 07 in the conveying direction. The impact device 09 essentially comprises a bearing shaft 10 provided with a shaft brake, on which a supply roll 11 of the separator sheet web 07 is rotatably mounted, two deflection rollers 12 and 13, a deflection device 14 designed as a deflection bar and a pair of draw rollers 15. The separator sheet web 07 is pulled from the supply roll 11 and conveyed in the direction of the feeding device 06 by means of the pair of draw rollers 15. At the same time the bearing shaft 10 can be decelerated by a controlled braking means so that the separator sheet web 07 has a predetermined tensile stress between the supply roll 11 and the pair of draw rollers 15. By means of this tensile stress the separator sheet web 07 is deflected around the defection device 14 at a deflection angle 30 of approximately 140 degrees and thereby a residual-stress state is generated which causes the unstressed separator sheet web 07 to roll up automatically. In other words, due to the tensile stress and the deflection angle, the separator sheet web 07 is “curled” by the deflection device 14 in a manner which causes the unclamped separator sheet web to roll up.

Due to the residual-stress state generated by the impact device 09, the separator sheets 04 roll up both at the front edge and at the rear edge after the cutting-to-length process has been performed by means of the cutting-to-length device 08 and with each of their cutting edges come to rest on the upper side of the dough pieces 03. This is further explained below with reference to the drawings FIG. 4 to FIG. 6. Subsequently, the dough pieces 03 with their assigned separator sheets 04 are rolled up in the winding device 16 to form rolls 02 and can then be conveyed to a packaging station by means of a conveyor belt 17.

FIG. 2 shows a side view of the device 01.

FIG. 3 shows an enlarged view of the deflection device 14. It can be seen that the deflection device 14 engages with a wedge-shaped deflecting edge 27 at the separator sheet web 07 over the entire width.

With reference to the drawings FIG. 4 to FIG. 6, the method according to the disclosure shall be further explained. The transfer point for the transfer of the dough pieces 03 from the feeding device 06 to a downstream conveyor belt 20 is situated below the cutting-to-length device 08. In the process state shown in FIG. 4, the cutting-to-length device 08 still is at a distance above the separator sheet web 07 and the separator sheet web 07 is conveyed in the conveying direction 21 with the dough pieces 03 resting on it.

FIG. 5 shows the cutting-to-length device 08 during the cutting motion in the actuating direction 25 shortly before cutting through the separator sheet web 07 at a predetermined position. The length of the front protrusion 22 and of the rear protrusion 23, with which the separator sheet 04 protrudes at the front or at the rear with respect to the dough piece, after termination of the cutting-to-length process, is visible.

FIG. 6 shows the dough pieces 03 and the separator sheet web 07 after the cutting-to-length process has been performed by means of the cutting-to-length device 08. The front protrusion 22 of the separator sheet 04 rolls over the front edge 18 of the dough piece 03 because of the residual-stress state generated in the separator sheet web 07 by means of the impact device 09 so that the front edge 19 of the separator sheet 04 comes to rest on the upper side of the dough piece 03. At the same time also the rear protrusion 23 of the preceding separator sheet 04 rolls up. As a result, due to the rolling up of the separator sheet 04 at the front edge 19 and the rear edge 24, a distance 29 is formed between two separator sheets 04 arranged one after the other so that it is possible to work with a higher conveying speed. Furthermore, the rolling up of the protrusions 22 and 23 caused by the residual stress of the separator sheet web 07 prevents the cutting edges 19 and 24 of the individual separator sheets from moving uncontrolledly during the process following the cutting-to-length process, in particular during the rolling up of the rolls 02, and thereby from causing disruptions.

FIG. 7 shows an enlarged side view of the winding device 16 at the beginning of the process of rolling up a roll 02. The beginning of the process of rolling up a roll 02 can be seen. At the beginning of the rolling up process, the front edge 18 of the dough piece 03 is rolled up together with the separator sheet 04 lying below it to form the core of the roll 02. Thereby, the front edge 19 of the separator sheet 04 protrudes over the front edge 18 of the dough piece 03 and rests on the upper side of the dough piece 03. The protrusion of the separator sheet 04 is placed on the upper side of the dough piece 03 by the rolling up of the roll 02 so that the front edge 18 of the dough piece 03 is enveloped by the front protrusion 22 of the separator sheet 04. Thus, uncontrolled movements of the front edge 19 of the separator sheet 04 are avoided and technical disruptions due to inadmissibly deformed separator sheets 04 are avoided.

A holding-down device 28, which serves to unroll the rolled up rear protrusion 23, is in its pivoted back rest position so that the dough piece 03 can be conveyed into the winding device 16.

FIG. 8 shows the winding device 16 at the end of the process of rolling up the roll 02. As soon as the dough piece has completely been conveyed into the winding device, the holding-down device 28 is pivoted downward and thereby prevents the rolled up rear protrusion 23 from being drawn in. The rear protrusion 23 is drawn through between the upper strand of the conveyor belt 20 and the tip of the holding-down device 28 and is unrolled thereby.

FIG. 9 shows the winding device 16 after termination of the process of rolling up the roll 02. The winding device 16 opens toward the bottom and the roll 02 which is fully rolled and fixed in its shape falls down onto the conveyor belt 17.

FIG. 10 shows the roll 02 made of a dough piece 03 and an assigned separator piece 04, which has been rolled up in the winding device 16. The front edge 18 of the dough piece 03 forms the core of the roll 02, the front edge 18 being flashed by the front protrusion 22 of the separator sheet 04.

After the roll 02 has been rolled up, the rear protrusion 23 envelops the entire roll 02 in an additional winding layer so that the roll 02 is fixed in its shape by the protrusion 23 wrapped around it.

1. A method for producing a roll made of a dough piece and a separator sheet, comprising:
a) feeding the dough piece onto a separator sheet web moved in a conveying direction;
b) cutting-to-length the separator sheet web to form a separator sheet which is assigned to the dough piece and has a front edge in front of the dough piece and a rear edge behind the dough piece , the separator sheet protruding from below the dough piece at the front edge and/or the rear edge with a front protrusion and/or a rear protrusion;
c) rolling up the separator sheet with the dough piece to form the roll;
wherein
a separator sheet web is used which has a residual-stress state, the residual stress of the separator sheet web causing the cut-to-length separator sheet to roll up automatically at the front edge and/or the rear edge after termination of the cutting-to-length process.

2. The method according to claim 1, wherein the front edge of the separator sheet comes to rest on the upper side of the dough piece by rolling up automatically after termination of the cutting-to-length process, the front protrusion of the separator sheet being folded over the front edge of the dough piece when the roll is rolled up.

3. The method according to claim 2, wherein the rear protrusion of the separator sheet envelops the roll made of the dough piece—and the separator sheet on the outside and serves as a fixing element for fixing the roll.

4. The method according to claim 1, wherein a distance is formed in the conveying direction between the separator sheets arranged one after the other by the automatic rolling up of the separator sheet at the front edge and/or at the rear edge.

5. A device for producing a rolled up roll made of a dough piece and a separator sheet, having a feeding device in which the dough piece can be placed on a separator sheet web in the conveying direction, a cutting-to-length device by means of which the separator sheet web can be cut-to-length into individual separator sheets, each of which is assigned to a dough piece, and a winding device by means of which a roll made of a dough piece and a separator sheet can be rolled up; wherein the device comprises an impact device by means of which the residual-stress state of the separator sheet web can be varied, the residual stress of the separator sheet web generated in this way causing the separator sheets to roll up automatically at the front edge and/or the rear edge after termination of the cutting-to-length process.

6. The device according to claim 5, wherein the impact device comprises a traction conveyor device and a deflection device, wherein tensile stresses can be exerted on the separator sheet web by means of the traction conveyor device, and wherein the separator sheet web, which is under tensile stress, can be deflected at the deflection device by a deflection angle.

7. The device according to claim 6, wherein the deflection angle of the deflection device is between 90 degrees and 179 degrees.

8. The device according to claim 6, wherein the traction conveyor device comprises a pair of draw rollers disposed downstream of the deflection device in the conveying direction, the separator sheet web being able to be conveyed through said pair of draw rollers by applying a driving force.

9. The device according to claim 6, wherein the traction conveyor device comprises a braking means disposed i upstream of the deflection device in the conveying direction, the conveying movement of the separator sheet web being able to be decelerated by means of said braking means.

10. The device according to claim 9, wherein the braking means is formed like a shaft brake by means of which a bearing shaft, on which a supply roll of the separator sheet web is rotatably mounted, can be decelerated.

11. The device according to claim 6, wherein the deflection device is formed like a deflection bar which comes into contact with a deflecting edge at the separator sheet web.

12. The device according to claim 11, wherein the deflection device engages with a wedge-shaped deflecting edge at the separator sheet web.

13. The device according to claim 5, wherein the cutting-to-length device is formed like a bar knife.

14. The device according to claim 5, wherein the device comprises an adjustable holding-down device which can be adjusted between an engaged position and a rest position, the holding-down device coming into contact with the rear protrusion of the separator sheet in the engaged position, and the holding-down device allowing the dough piece to be conveyed through to the winding device in the rest position.
